(19) United States
(12) Patent Application Publication
(10) Pub. No.: US 2007/0143171 A1
(43) Pub. Date: Jun. 21, 2007

(54) Target pricing method

(75) Inventors: Dean Boyd, Cottage Grove, OR (US); Thomas Guardino, Eugene, OR (US); Robert L. Phillips, Palo Alto, CA (US)

Correspondence Address: QUARLES & BRADY LLP, RENAISSANCE ONE, TWO NORTH CENTRAL AVENUE, PHOENIX, AZ, 85004-2391, US

(73) Assignee: Manugistics, Inc.

(21) Appl. No.: 11/444,314

(22) Filed: Jun. 1, 2006

Related U.S. Application Data
(63) Continuation of application No. 09/517,977, filed on Mar. 3, 2000, now abandoned.
(60) Provisional application No. 60/123,345, filed on Mar. 5, 1999.
(60) Provisional application No. 60/122,958, filed on Mar. 5, 1999.
(60) Provisional application No. 60/178,501, filed on Jan. 27, 2000.

(51) Int. Cl. G06Q 99/00; G06F 17/30; G07G 1/00

(52) U.S. Cl. 705/10; 705/1

(57) ABSTRACT

A method and process of target pricing a value, such as a bid, or other price which includes the steps of pricing the value using stored list prices in a product model, costing the value using stored costs in the product model, calculating. an equivalent competitor net price for the value using a competitor net price model, calculating. the probability of winning the value as a function of price using parameters from a market response model, and calculating a target price for the value. The preferred target price maximizes expected contribution using an optimization model that determines competitive response to any potential value, or bid. The method and process further preferably include the steps of calculating one or more benefits of target pricing in comparison to a pre-existing pricing approach, determining a target range for the target price to be within, and determining strategic objects that constrain the target price of the value or bid.

### CROSS-REFERENCE TO RELATED APPLICATIONS

This application claims the benefit of U.S. Provisional Applications Ser. No. 60/123,345, filed Mar. 5, 1999, Ser. No. 60/122,958, filed Mar. 5, 1999, and Ser. No. 60/178,501, filed Jan. 27, 2000.

### BACKGROUND OF THE WNTION

1 . Field of the Invention

This invention generally relates to a method and process for generating target prices for optimum bids or prices in a competitive business-to-business selling situation. More particularly, the present invention relates to a method and process for generating optimal target prices for sales of or contracts for products or services in a competitive business-to-business selling situation.

2. Description of the Related Art

In certain industries, companies bid on work to be performed on behalf of third parties, such work typically being either the production of a product or the provision of a service. Such companies often competitively bid against one another for a contract to perform work for a specific third party. In making a bid for a contract or to provide a certain set of products or services, the goal is to make an exact bid. where the company balances the likelihood of wining the bid at a given price with the profit that will be obtained of the bid is won at that price, or bid a “target price” for the given contract.

In order to make a satisfactory bid to obtain a contract or other agreement for the provision of a product or service, a company must evaluate the aspects for the specific bid parameters that if properly reflected in the bid price enable the company to properly balance the likelihood of winning the bid with the profit achieved if the bid is won. Traditionally, bid pricing has been assisted by computer systems that estimate the cost of serving individual customers, taking into account the special factors affecting the bid price. These typical “cost-of-service” based-bidding systems compute a price floor or minimum bid for a prospective contract or agreement based on the cost of delivering the products or services and the actual calculation of profit for the contract is subjectively left to the company. Consequently, while the traditional cost-of-service based bidding systems can provide guidance on the minimum bid, they provide no guidance for the optimal way to balance the likelihood of winning the bid with the profit achieved if the bid is won. This guidance can only be provided if a target price is established that balances the likelihood of winning the bid with the profit achieved if the bid is won by maximizing the expected profit that is achieved by the target price.

Furthermore, traditional cost-of-service based bidding systems have a number of drawbacks as pricing tools for competitively bid goods and services as they lack the ability to factor the market response of customers and competitors to pricing decisions. This is mainly because the systems are cost-focused, even though clients may increasingly demand products and services that are tailored to their specific needs. The traditional cost-of-service based bidding systems also lack the ability to track and analyze post-bid information, such as wins and losses, profitability of won bids, and otherwise capture useful data which can be analyzed for the generation of future bids.

There are systems in the at such as in airline seat and commodities pricing, that can reflect market and competitor response characteristics in bid pricing. However, such systems typically generate pricing information for an individual product or service at a particular point in time, such as an airline seat on a particular flight or a specific commodity futures contract. As a result, these systems are not directly applicable to bidding systems for all bid-upon services, which usually price a portfolio of services to be performed over an extended contract period.

Thus, there is a need for a method of bid pricing that takes market and competitor response characteristics into account when generating bid prices. There is a further need for a bid pricing method that takes market and competitor response characteristics into account when generating bids for portfolios of products and services to be performed over extended contract periods. It is to the provision of such an improved method that the present invention is primarily directed.

### SUMMARY OF THE INVENTION

In a preferred embodiment, the present invention is a method of target pricing a value, that includes the steps of pricing the value using list prices in a product model, costing the value using the costs in the product model, calculating an equivalent competitor net price for the value using a competitor net price model, calculating the probability of winning as a function of price using the parameters from a market response model, and determining a target price for the value by selecting a price that maximizes the expected contribution. The method preferably further includes the step of calculating the benefits of target pricing in comparison to the pre-existing pricing approach using a benefits model. Additionally, the method Also preferably includes the step of calculating. a target range for the bid.

The user of the target pricing method can preferably override the calculated equivalent competitor net price so long as the over-ride is within a predetermined range. Further, the product model and the competitor price model are dimensional with stored data reflective of at least price and cost, such that the steps of pricing the bid, costing the bid, and calculating an equivalent competitor net price are performed by iterative linear interpolation of the stored data.

In a further embodiment, the present invention is a method and process of target pricing a value, such as a bid, that includes the steps of pricing the bid using stored list prices in a product model, costing the bid using stored costs in the product model, calculating an equivalent competitor net price for the bid using a competitor net price model, calculating the probability of winning the bid as a function of price using parameters from a market response model, and calculating a target price for the bid that maximizes expected contribution using an optimization model that determines competitive response to any potential bid. The method and process preferably further include the step of calculating one or more benefits of target pricing in comparison to a pre-existing pricing approach, and the step of calculating a target range for the bid.

The step of calculating an equivalent competitor net price preferably further includes the steps of retrieving a price from the product model for a specific bid, arid applying a discounting model to the price to determine a competitor net price for the specific bid. Further, the market response model preferably includes coefficients for market response predictors based upon historical data, and for a specific bid, the step of calculating the probability of winning the bid includes the steps of evaluating price-independent predictors, and generating a market response curve from which an estimated probability of winning a bid is calculated.

The step of evaluating price-independent predictors is preferably evaluating price independent predictors for at least the customer, the order, and the product. And the method and process further include the step of evaluating static and variable price-independent predictors.

The step of calculating one or more benefits of target pricing also includes the steps of obtaining the target price for the specific bid, calculating a bid price using a pre-existing pricing approach, and comparing the bid from the pre-existing pricing approach to a market response curve to determine the probability of a successful bid with the pre-existing pricing approach. Further, the step of calculating a bid target price preferably using a preexisting pricing approach is a step selected from the group of: discounting the list price from the price model, adding a predetermined amount to the cost for the bid, and matching a historic rate for the specific bid.

The method and process further preferably include the steps of calculating a specific target bid price for a performance of a contract, determining, the applicability of one or more strategic objectives to the target bid price, calculating a target range for the target bid price that is constrained by the one or more strategic objectives, and obtaining a target price that is within the target range. The step of determining the applicability of one or more strategic objectives is a step selected from the group of: obtaining a pre-determined maximum or minimum margin on the bid, and obtaining a pre-determined maximum or minimum success rate on the bid.

When the method and process includes the step of calculating a target range, such step is preferably selected from the group of calculating a target range from the maximum expected contribution, and calculating a target range based upon the optimum target price.

Use of the target pricing methodology enables an entity to optimize its pricing and associated business processes in order to increase expected profit for a bid or other calculated value. Target pricing utilizes information about competitors, costs, and market response behavior to set customer-specific prices that maximize expected financial contribution. The resulting incremental improvements ii profitability can add up to significant gains for the target pricing user.

In considering these factors, the present inventive process and method provide an optimal balance between the likelihood of winning a bid and the profit to be earned from a bid-upon contract (i.e., the contribution margin) if the bid is won. More specifically, the market response curve of the market response model that is generated for each bid reflects the likelihood of winning the bid as a function of bid price. There is also generated a corresponding contribution margin curve for the bid based on the cost of completing the contract as a function of bid price. The products of these two curves produces the expected contribution curve as a function of bid price. The bid price corresponding to the peak value of this expected contribution curve is the target price, or optimal bid price, for that particular bid.

The present inventive method and process accordingly have industrial applicability as they give the user the ability to develop accurate market response curves for individual bids. These market response curves are generated by identifying a number of factors that appear to influence the ultimate market response. To isolate the correlation between specific drivers and the ultimate market response, a large database of historical bid information is collected. This database includes bid price, identification of competitors, and win/loss data for each bid, as well as information relating to the various factors for each bid. Regression analysis is then preferably performed on the data to identify the correlation between the various factors and the market response. These correlations are then used to predict market response for future bids. This approach can be used to develop separate customer and competitor response curves, or it can be used to develop a single or combined market response curve. This approach can also be segmented by geographical region, type of customer, type of service, or any other type of division that appears to be appropriate for a particular application.

It should be understood, therefore, that the invention gives a commercial advantage to the user as the target pricing method and process can be used to provide bids in a wide range of industries, for goods as well as services. Although the target pricing method is particularly useful for identifying and utilizing factors that influence market response for significant numbers of goods or services, and the same techniques may be applied to predicting the market response to bid prices for individual goods or services.

Other objects, advantages, and features of the present invention will become apparent after review of the hereinafter set forth Brief Description of the Drawings, Detailed Description of the Invention, and Claim.

### BRIEF DESCRIPTION OF DRAWINGS

FIG. 1 is a graph illustrating the market response curve, the contribution and expected contribution curves for use in the market response model.

FIG. 2A is a bifurcated graph illustrating the win probability curves for a large and small volume customer for volume-based segmentation.

FIG. 2B is a bifurcated graph illustrating the win probability curves for a large and small volume customer for region-based segmentation.

FIG. 3A illustrates a graph denoting wins and losses with baseline points plotted.

FIG. 3B illustrates the graph of FIG. 3A with a win/loss curve plotted by a logistic function.

FIG. 4 is a block diagram illustrating the key objects of the target pricing method.

FIG. 5 is a flow chart depicting the steps in a target pricing method in accordance with embodiments of the present invention.

### DETAILED DESCRIPTION OF THE INVENTION

With reference to the drawings and the specification for the present inventive target pricing method, the terms as used herein are hereby defined as follows:
“Account”: The highest level in business to business transactions. Accounts represent relationships with client businesses.
“Allowable Range”: When gathering bid information, account executives can provide field observations of the competitor net price rather than rely on the competitor net price model. The allowable range specifies how far the determined value may be from the model's estimated competitor net price. The allowable range is ultimately determined by the system owner. See also Warning Range.
“Bid”: A bid is a clearly specified package of goods and services (called products in the Target Pricing context) for which the price will be negotiated (rather than automatically quoting list price). Also called a bid proposal.
“Bid Characteristics”: Predictors based on attributes of the bid system object (as opposed to those based on attributes of the account system object).
“Bid Drivers”: See Predictor.
“Bid Status”: Bid status specifies the current stage of negotiation for a given contract. Bid status currently supported by the Target Pricing system include:
   “Under Construction”: Account executive is in the process of putting the bid together.
   “Pending”: Account Executive is currently negotiating the bid.
   “Accepted”: The contract for the bid has been signed.
   “Rejected”: The bid was not acceptable to the customer.
   “Inactive”: The bid was previously active, but the contract has ended.
“Coefficient”: Every predictor has an associated coefficient calculated by the Market Response Model. Win probability is a function of these predictors (which measure key attributes of the accounts and the bids) and their coefficients (which measure the relative weights of the predictors in estimating win probabilities). Also called a regression coefficient, since they are calculated using a logistic regression routine.
“Company”: An object storing information about the business using target pricing and its competitors. Client businesses are referred to instead as accounts.
“Competitor”: A company whose products may be chosen by accounts to the exclusion of those of the Target Pricing user. More specifically, an object which records interesting data about the (physical) competing company. Associated with competitor objects are competitor products and a competitor net price model.
“Contribution, Expected”: The product of marginal contribution and win probability (expected contribution=marginal contribution x win probability). The expected contribution curve is the product of the market response curve and the marginal contribution curve, and shows expected contribution as a function of net price.
“Contribution, Marginal”: A measure of net revenue showing the excess of revenue over immediately incurred costs (marginal contribution=net price−marginal cost). The marginal contribution curve depicts the relationship between net price and marginal contribution. This
“curve” is always a straight line.
“Cost”: The target pricing methodology is only valid when applied to marginal costs, and so all references to costs or cost models refer to these. One can track other cost measures (including allocated overhead and opportunity costs) for reporting purposes.
“Cost, Marginal”: The incremental and avoidable costs of meeting the service requirements of the bid proposal. If the proposal includes a probabilistic element like warranty service, then the marginal cost is implicitly an expected value.
“Cost Model”: An object which estimates the marginal cost of a product using a lookup table and an (optional) interpolation algorithm. Models may estimate prices using zero to three dimensions or through a functional relationship, or from external sources.
“Discount”: The usual mode of operation for target pricing is to accept list prices and compute target discount levels. Discounts can be specified in terms of percentage off of list price, absolute dollar price, absolute dollar discount and ratio of our net price to competitor net price.
“Duration”: Duration is specified in the system to help convert quantities entered at one level to another. (E.g. if a weekly order for a product is entered in the system, but the market response model is maintained for quarterly quantities, the system converts quantities from one period to quantities over the other period automatically.) Examples of these periods include: Daily, weekly, monthly, quarterly and yearly.
“Global Dimension”: The target pricing method includes a global dimension list specifying all of the axes along which accounts, bids, or companies may aggregated. These global dimensions are used anytime a collection of these objects must be specified or selected, and by default include all of the attributes of the objects.
“Marginal Contribution”: Contribution made to the bottom line as a result of selling one unit (marginal contribution=net price−marginal cost).
“Market Response Parameters”: Synonym for coefficients. See also Parameter.
“Market Response Curve”: The market response curves shows: the probability of winning a bid as a function of net price, for a particular market segment and holding competitor net price constant. Determining the market response curves is one of the major consulting tasks at the time of implementation, and is discussed herein
“Market Segment”: A distinct cluster of customers whose buying behavior (market response curves) is similar. Such a cluster is defined in terms of key measurement axes called market segmentation criteria, represented in the system as global dimensions. Together these criteria specify the market segmentation scheme, and capture all aspects of a customer which are of interest in predicting win probabilities.
“Option”: A product feature which can be acquired for an additional payment. Target pricing can also use options to model closely related products as variations of a single “virtual product” which may not be offered in the market as a standalone. Zero or more options may exist for a given product. Options are maintained in units per unit of product. (e.g. three-year warranty for one automobile).
“Order, Option”: An object storing such information as quantity desired for any options ordered as part of a product order.
“Order, Product”: An object storing such information as quantity desired for each product involved in a bid.
“Parameter”: A parameter is an object which controls the system's behavior or performance. These include the current definitions of global dimensions and predictors, and the current values of the coefficients. They also include various switches and values indicating preferred algorithms (where there are choices), an example being the choice of currency units. The collection of all parameters is called a parameter set. While only one parameter set can be active at a time, all historical parameter sets are stored to support retrospective analysis of performance.
“Predictor”: Predictors are measurements or indicator variables used to estimate (or “predict”) the win probability for a bid. They can be based on attributes of either the bid or account objects. Initial sets of predictors, called bid drivers, are defined at the time of system installation. Additional predictors can then be created by the system owner using the existing ones and any global dimensions. The market response model fits a coefficient for every predictor.
“Price, List”: The “standard” price for customers who do not negotiate, or the starting price for negotiations. “List” prices may or may not be publicized.
“Price, Maximum”: see Price Range.
“Price, Minimum”: see Price Range.
“Price, Net”: Price net of discounts off the list price.
“Price, Target”: The price which balances win probability and marginal contribution to maximize expected contribution. The constrained target price must maximize expected contribution subject to specified strategic objectives, while the unconstrained target price shows the optimal price in the absence of such long-term considerations.
“Price Model”: An object which estimates prices using a lookup table and an (optional) interpolation algorithm. Price models are used to provide list prices and competitor net prices, and may estimate prices using zero to n dimensions or through functional relationships or by retrieval from external systems.
“Price Range”: As well as the contribution-maximizing target price, target pricing computes a minimum price and a maximum price within which account executives can negotiate bids.
“Product”: Products are the smallest items for which an optimum discount level is computed. Physical products are represented using both product and option objects, The list of products is maintained by the user, along with list. price and cost information, the list of their available options, and any competitor products that compete with them.
“Product Line”: A collection of similar products. Target pricing allows a single price model to be shared by all of the products in a product line.
“Revenue”: Target pricing uses several measures of revenue and profit. See Contribution, Expected; Contribution, Marginal; Revenue, Gross; and Revenue, List.
“Revenue, Gross”: All revenue received from the customer, i.e. the price that was offered and accepted (gross revenue=list price*(1−discount)*quantity).
“Revenue, List”: The revenue that would be received if a bid were won without offering any discount (list revenue=list price*quantity).
“Strategic Objectives”: Business requirements established by senior management to promote long-term corporate growth, possibly at the expense of near-term profits. Target Pricing supports direct entry of binding constraints in terms of:

“Minimum Success Rate”: All affected bids will be priced to maintain the specified minimum win probability.

“Maximum Success Rate”: All affected bids will be priced to maintain the specified maximum win probability.

“Profit Margin Objectives”: All affected bids will be priced to maintain the specified gross margin (gross margin=1−gross revenue/marginal cost).
“Success Rate”: The ratio of bids accepted to bids offered.
“Win Probability”: Estimated probability of winning a bid at a given net price. The function relating win probabilities to net prices (holding all else constant) is the market response curve, sometimes carted the win probability curve.

The preferred embodiment of the present inventive method calculates the optimum target price for making a bid which will be both profitable to the company making the bid, and which takes into account the likely bids of other third party bidders such that the company's bid is competitive. However the present method and process can be alternately used to calculate a value, such as an optimal price, in the same manner as the preferred embodiment calculates an optimal bid. Furthermore, as this application claims the benefit of U.S. Provisional Applications Ser. No. 60/123,345, filed Mar. 5, 1999, Ser. No. 60/122,958, filed Mar. 5, 1999, and Ser. No. 60/178,501, fled Jan. 27, 2000, the subject matter of those applications is expressly incorporated herein in its entirety by this reference.

To calculate the target bid price, several steps need to be performed. Initially, the bid must be priced preferably using the list prices in a product model, as discussed below. These prices may be gathered directly from current data or obtained from a 3rd party or proprietary pricing system. Other third party software products such as Siebel Sales and Trilogy SC Pricer can be used in generation of the initial prices.

Then the bid is costed using the costs in the product model. These costs may either have been gathered manually or obtained from a proprietary costing system from third parties as is known in the art or could be retrieved in real-tine from external systems or sources.

Once the bid is costed, then an equivalent competitor net price for the bid is calculated. This is the price the competitor(s) would charge to this customer after any discounting has occurred. The list prices for competitor products are preferably maintained in the product model, but an appropriates discounting mechanism must be applied to the list prices to determine the net price. This is preferably done by a competitor net price model as discussed below. Then the probability of winning the bid as a function of the company's price is calculated. This is preferably calculated using the parameters from a market response model as described below.

In addition, the benefits of target pricing over the company's existing pricing approach can be calculated. The logic for the preexisting pricing method is preferably maintained in a benefits model as described below.

As is apparent from review of the above steps, the present inventive method is readily adaptable for use in an automated system, such as in software executing on a computer platform. Nonetheless, the steps of the present method can be performed by hand as the models as disclosed herein can be generated and maintained manually.

The method further preferably includes optimization processes to generate the optimum target bid price. The first optimization step is to compute the price that maximizes the expected contribution for the bid, which is done by balancing the contribution which increases as price increases, and the win probability, which decreases as price increases.

Given the target price computed above, any discounts must be applied to each product within the bid. This is performed using a second optimization process. The steps of balancing of the contribution and the win probability are repeated taking into account any strategic objectives that have been specified. Examples of strategic objectives such as minimum success rates can override the initial values calculated.

The present inventive method utilizes a market response model in calculating the target bid price. The market response model (MRM) calculates the win probability as a function of price through the examination of historical bid information at various prices. The MRM requires that the customers be segregated into distinct market segments. The market segments are determined through a detailed analytical investigation prior to the use of the present method. A further module that is alternately used in the present method is a reporting module that is used to produce reports on a regular or ad-hoc basis.

Many situations require that the target pricing method user select or specify a group of similar objects, for example “all small accounts.” This is implemented with a “global dimension object,” which specifies a grouping variable (like size) derived from the attributes of an object. This operation can be applied to company, bid, account, or product objects, and is used in market response modeling for estimating how different types of customers react to different prices. It is also used in reporting as it enables the user to analyze results in order to understand system and/or customer behavior. Further, the global dimension object can be used in applying strategic objectives which enable the user to modify the default operation of the system in order to achieve specific strategic goals, such as minimum win rates.

The dimensions allow competitor net price modeling which enables the user to model competitor discounting behavior once again using some form of market segmentation. It also allows benefits modeling that enables the user to model preexisting (“business-as-usual”) pricing methods.

Global dimensions are created whenever the user of the target pricing method desires to do one of the above. And as one might assume, they can be used for more than one of the above purposes. For many of these uses, the global dimensions are used for segmenting the TP user's customers, i.e., as market segmentation criteria.

There are three distinct types of global dimensions: discrete, continuous, and hierarchical. Discrete segmentation is used to group customers into specific buckets. For example, consider the following discrete market segments: North, South, Other. A customer will be grouped into one and only one of the 3 segments: North, South or Other.

Continuous segmentation is used to group customers into specific buckets using a continuous indicator variable. For example, consider the following continuous market segments of Annual Revenues: Small: 0-$10 M; Medium: $10-50 M; Large: Over $50M. Customers will be grouped. into either Small, Medium or Large depending on their annual revenues. As their annual revenues change or the definition of the Small/Medium/Large breakpoints changes, the customers will be automatically reclassified. The underlying continuous variable (revenue) is called the “base variable.”

Hierarchical market segmentation is a specialized form of discrete market segmentation, where there is more than one layer of segmentation. For example, consider the following Hierarchical market segmentation of Geographic Region: North: Maine, New York, etc.; South: Florida, Georgia, etc. A customer from New York is classified in the New York segment, as well as the North segment.

Accordingly, market segments are used for purposes such as market response modeling, reporting, strategic objectives, price and cost modeling, competitor net price modeling, and benefits modeling.

Market segments are used for market response modeling in the following manner: any market segments that are defined for a specific TP installation are automatically available for Market Response modeling. However, it should be noted that since each segmentation criteria that is added increases the dimensionality of the sample space, there is a finite limit to the number of market segments that can be used while still maintaining the statistical integrity of the system. For example, consider the following market segments: Customer size: small, medium, large; Account size: small, medium, large, Customer region: NE, SE, NW, SW; International Industry: Manufacturing, Service.

The sample space implied by this set of customer segments is: 3×3×5×2=90. This means that for every 90 bid transactions we are able to observe, there is (on average) 1 observation per (final) customer segment. In reality, since some of the market segments will be more populous than others, there will be many market segments where no observations are recorded. This characteristic may double, triple or more the total number of observations needed In addition, note that we need wins as well as losses, so the required number of transactions will be doubled. As a result, suppose that at least 10 wins and 10 losses are needed to model each market segment (the exact number will depend on how closely correlated the data is). This implies that for the above, we will need:

$$\frac{\begin{matrix} ( 90 market segments ) \\ * ( 20 observations ) \\ * ( 2.5 assumed sparseness factor )\end{matrix}}{= 4500 observations }$$

This number is reduced considerably if one of the above market segments is removed. For example, with the Region segment removed, we only need:

$$\frac{\begin{matrix} ( 18 market segments ) \\ * ( 20 observations ) \\ * ( 2.5 assumed sparseness factor )\end{matrix}}{= 900 observations }$$

Market segments are used for reporting purposes. Any market segments that are defined for a specific target bid price can be used in reports. The market segments can be selected to aggregate data along the x-axis. For example, in the above example, we could produce reports that displayed average target prices by: Customer size, Account size, Customer Region, and industry.

Market segments are used to enter strategic objectives. Examples of a strategic objective are the minimum/maximum win rates. Using the previous example, a user could decide to increase market share by: Customer size, Account size, Customer Region, and Industry. For example, a user may decide to set a minimum win rate of 40% for all Small customers in the NE who are in the Manufacturing Industry segment.

For product modeling, global dimensions are used to enable specification of product list price and (variable) costs, Any global dimensions that are defined for a specific target pricing bid are automatically available to use for price and cost modeling. Both list prices and costs as maintained in the product model.

For competitor net price modeling, global dimensions are defined for a specific target pricing bid by allowing discounts to be applied to competitor list prices across any defined global dimension. The discounts are used to arrive at net prices. The competitor list prices are maintained in the product model.

For benefits modeling, global dimensions are used to compute the target pricing benefits. Benefits are modeled by simulating the difference between target prices and their corresponding expected contribution versus prices as determined before usage of the target pricing method and their corresponding expected contribution level. Prices determined before the usage of target pricing can be modeled using global dimensions.

The market response model (MRM) performs three key functions: updating the coefficients for market response predictors on the basis of historical data (these updated values can be rejected or altered by the user); for a particular hid, evaluating the price-independent predictors to generate a market response curve that depends only on price; and for a particular bid and offered price, calculating the estimated probability of winning (“the market response”).

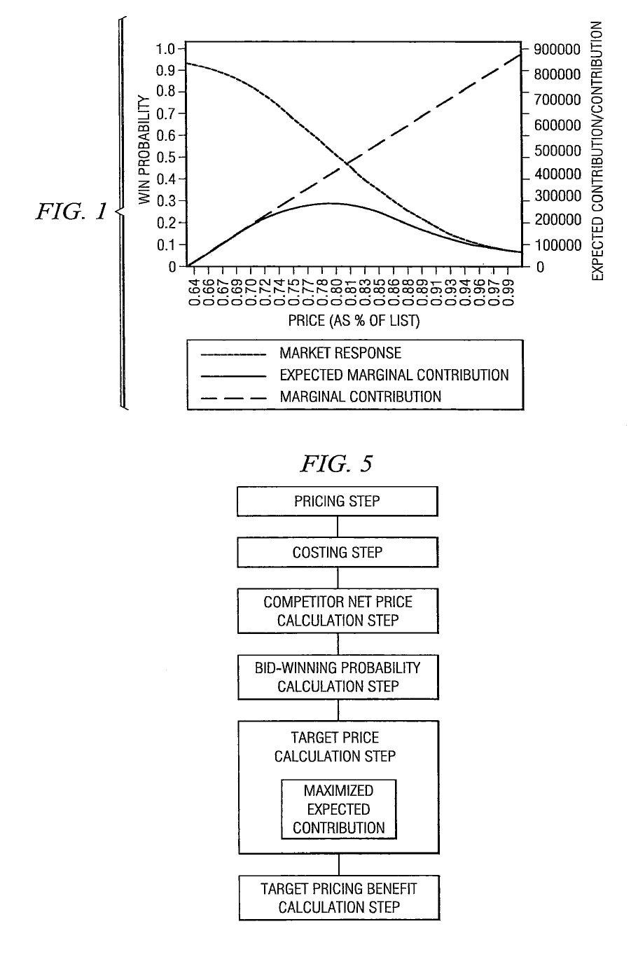

Predictors can be market segmentation criteria (as defined by the user), bid drivers, or a product of several of these. For every predictor specified by the user, the coefficient values that define the market response curve are estimated and stored. These coefficients are used in combination with account and bid characteristics to calculate win probabilities. The market response curve and win probabilities are illustrated in the graph of FIG. 1.

Coefficients fall into two categories: price-dependent and price independent When computing the optimal (target) price, price-independent terms can be viewed as constants and computed in advance. The main inputs arc: market segments; and price-dependent and price-independent predictors for each market segment. The main outputs are: price-independent and price-dependent coefficients; bid-specific market response curves; and bid- and price-specific win probability estimates.

Bid characteristics are determined. by the target pricing method user prior to beginning the steps of the method. The specific value used in a particular regression is based on the interpretation for the characteristics. Once the market segmentation and bid characteristics have been defined, price-independent and price-dependent have to be made so that these characteristics can be used in probability determination. Since these parameters are used for modeling customer behavior, some of the transformations may not be very intuitive at the outset. For example, logarithmic expressions have been used extensively to dampen the possibility of large swings in probability due to large changes in any one parameter.

Below is a list of example bid characteristics.

Bid Characteristics

| Characteristic | |
|---|---|
| Name | Description |
| Bid volume | Quantity ordered for a given portfolio. |
| Bid Gross | List price * quantity for all products in the |
| | portfolio |
| Revenue | |
| Bid Contribution | Contribution = (revenue − cost) * quantity for all |
| | the products in a given bid. |
| Key competitor | For a pre-specified set of key competitors, define |
| | if any of the competitors exist for the given bid. |
| Key Product | Product with greatest revenue in bid |

The examples below represent the probability of wing as a function of increasing discounts. These curves are reversed in shape since they model the probability of winning against discounts (CE) offered instead of the probability of wing against price.

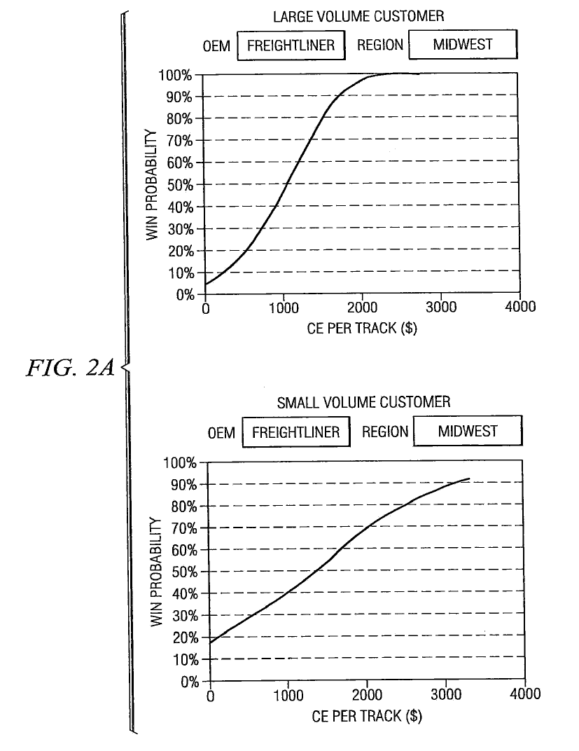

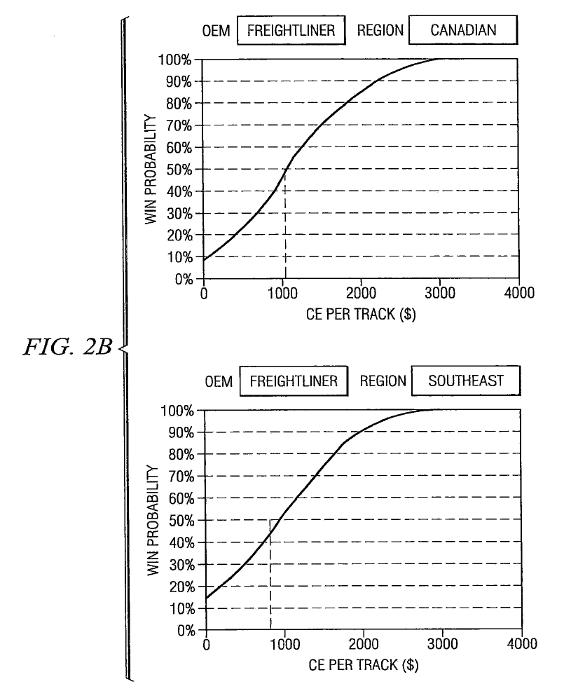

FIG. 2A illustrates a case where both brand preference and price sensitivity differs between customers with “large” and “small” order volumes. Note that the large volume customers show less preference for our brand (lateral shift of the market response curve) and greater price sensitivity (the curve is steeper in its central region).

FIG. 2B illustrates an example of regional segmentation. Since the second curve is shifted a little to the right, there is more brand preference in the Southeast region when compared to the Canadian region. While the curves are quite similar, there are differences, especially for smaller discounts.

The MRM uses historical bids containing win/loss information to run a statistical regression. The statistical regression uses the logic function to determine the best fitting market response curve. There are significant advantages of using the logistic form.

The logistic form ensures that the output is between zero and one for any set of characteristics. Further, It provides a smooth negative slope. This makes it easy to get price sensitivity from the first derivative. Mathematical properties of the logic function offer efficient numerical computation and an intuitive interpretation of the fitted coefficients.

For example,, if price is the only explanatory variable for modeling the likelihood of winning, one would have 10 historical bids containing win loss information as given below:

| Price | Win/loss |
|---|---|
| 1 | Win |
| 2 | Win |
| 3 | Win |
| 4 | Win |
| 5 | Win |
| 6 | Loss |
| 7 | Loss |
| 8 | Loss |
| 9 | Loss |
| 10 | Loss |

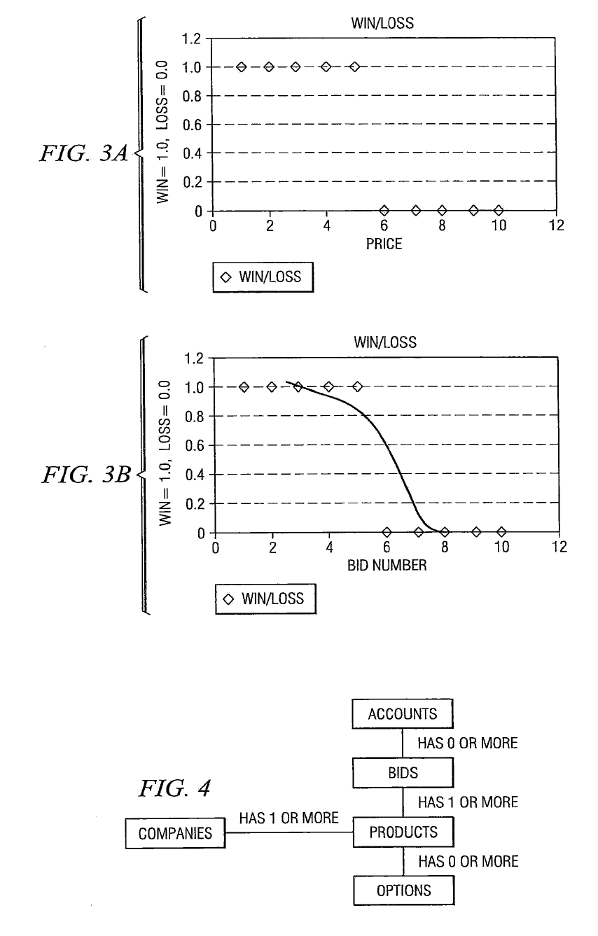

If win/loss is treated as a dummy variable where a win is identified by 1 and a loss is identified by 0, we get the following plot of win/loss against price as illustrated by FIG. 3A.

If we fit this plot to a logistic function, where the logistic function is defined as:

$$\begin{matrix}p ( x ) & \underline{1 } \\ = & \underline{1 + {ⅇ}^{- ( α + β x )}}\end{matrix}$$

One obtains the curve of FIG. 3B, where win/loss is a binary response variable, and alpha and gamma are the explanatory variables. With this curve it is easy to determine the probability of winning at any price. A simple example is given below to illustrate MRM calculations.
An Example: Meritor Heavy Vehicle Systems

Meritor manufactures different parts for truck drive trains. These parts are sold to the end customers through OEM's (like Volvo/GM) that manufacture trucks. Since most of the trucks are assembled by OEM's for end customers, Meritor has to figure out the discounts to offer end customers.

In the example below, a bid is tendered to the Trinity Steel account by Meritor Heavy Vehicle systems. The following customer segments are defined by the user of the target pricing method:

INPUTS
Market Segmentation

| | |
|---|---|
| Market Segment Name | Customer Size |
| Market Segment Interpretation | Small: 0 to 100, Medium: 101 to 500, |
| | Large 501 and greater |

The following bid characteristics are flier defined by the user:

Bid Characteristic

| | |
|---|---|
| Characteristic Name | LOGVOL |
| Characteristic Interpretation | Log of quantity ordered |

Accordingly, given below is a sample bid tendered to the account Trinity Steel:

Sample Bid

| | |
|---|---|
| Account No. | 1 |
| Account | Trinity Steel |
| Customer Size * | Medium |
| Bid No. | 1 |
| Product Ordered | Transmission - TR1234 |
| Quantity Ordered | 100 |
| Win/Loss | Win |
| Our Net Price | $55 |
| Competitor Net Price | $57 |

The market response variables are thus calculated:

| Problem Formulation | | |
|---|---|---|
| Variable | Formula for Conversion | Value Used |
| Alpha | | |
| Alpha 0 (Intercept) | Intercept variable set to 1 for | 1 |
| | every problem | |
| Alpha 1 (Discrete Cust. | Small = 0.0, Medium = 1.0, | 1 |
| Seg. - Dummy var.) | Large = 2.0 | |
| Alpha 2 (LOGVOL) | Log(quantity) | 2 |
| Gamma | | |
| Gamma 1 (Discrete Cust. | Alpha 1 * Log (PriceRatio) | −0.015512166 |
| Seg. - Dummy var.) | | |
| Gamma 2 (LOGVOL) | Alpha 2 * Log (PriceRatio) | −0.031024332 |

Multiple rows of similar bids containing win/loss information are calculated in a logistic regression routine, as shown below:

OUTPUTS
Coefficients Obtained By Regression

| Alpha | |
|---|---|
| Alpha 0 (Intercept) | −0.003 |
| Alpha 1 (Discrete Cust. Seg. - Dummy | −0.001 |
| var.) | |
| Alpha 2 (LOGVOL) | −0.0006 |
| Gamma | |
| Gamma 1 (Discrete Cust. Seg. - Dummy | −0.0008 |
| var.) | |
| Gamma 2 (LOGVOL) | −0.0003 |

Given these coefficients, the win probability of any bid can easily be calculated for a specific price. For the example above we have:

Calculating Probability of Winning

| | | |
|---|---|---|
| Sum of Alphas | = Alpha 0 + Alpha 1 + Alpha2 | −0.0046 |
| Sum of Gammas | = (Gamma1 + Gamma2) * | 1.70634E−05 |
| | (log (PriceRatio)) | |
| Prob of winning for | 1/1 + EXP − (Alphas + Gammas * | 0.499 |
| the bid | log (PriceRatio) | |
| above | | |

The win probabilities can accordingly be determined from the active parameter set that Contains the market response parameter used by the system to compute win probabilities.

The binomial case for win probability is:

$$\begin{matrix}Win Prob & \underline{1 } \\ = & \underline{1 + exp ( α + γ )}\end{matrix}$$

Where α=α₀+B₁α₁+B₂α₂+ . . . +Bₙαₙ
and where γ=β₀+D₁γ₁+D₂γ₂+ . . . +Dₙγₙ

The multinomial case for win probability is:

$$\begin{matrix}Win Prob & \underline{1 } \\ = & \underline{1 + {\sum }_{i} exp ( {α}_{i} + {γ}_{i} )}\end{matrix}$$

Where αᵢ=α₀+B₁ᵢα₁+₂ᵢα₂+ . . . +ₙᵢαₙ
and where γᵢ=γ₀ᵢ+D₁γ₁ᵢ+D₂γ₂ᵢ+ . . . +Dₙγₙᵢ

In each case, the α's and γ's are specific to a bid.

B₁, . . . Bₙ are bid specific brand preference and other price independent drivers and market segment variables.

Dᵢ, . . . Dₙ are bid specific price dependent drivers and market segment variables.

The α's are referred to as brand preference and other price independent parameters because a change in these parameters shifts the Market Response curve to the right (or to the left).

The α's are referred to as price dependent parameters because a change in these parameters changes the slope of the Market Response curve.

The price-independent predictors can be viewed as measures of customers' brand preferences. The price-dependent ones, however, provide a measure of customers' price-sensitivity, and determine the slope of the linear region of the market response curve. Fig. illustrates the impact of the predictor coefficients on the market response curve.

With respect to the preferred method of statistical regression:

$$Win Probability = \frac{1}{1 + {ⅇ}^{[ - α - γ x price ]}}$$

α represents the sum of price-independent coefficients. Note that as α increases, the curve representing the relationship between win probability and price shifts right, signifying increased brand reference. γ, on the other hand, sums the effects of a change in price. Hence, as γ increases, the curve representing the relationship between win probability and price becomes steeper, reflecting a change in price sensitivity.

For the logistic market response curve, there is always an inflection point where the win probability (WP) equals 0.5. The higher γ, the steeper the curve near WP=0.5, and the shallower at the endpoints. WP=0 and WP=1.

It should be noted that market segmentation models macro level customer behavior (e.g. region based market segments), and is therefore an integral part of pricing strategy. In the target pricing method, account characteristics can be used to identify market segments, enabling segment-specific net prices to be offered. In addition, characteristics of individuals bids (such as volume or key competitor) can further influence customers' brand preference and willingness to pay. The MRM therefore applies the characteristics of both the account and the particular bid when estimating bid probabilities.

There are basic business objects that enable the target pricing method to be deployed in multiple diverse industries and serve as its basic infrastructure for bidding. In particular, key objects, include: companies, accounts, bids, products, and options (including competing products and options).

“Companies”: a company is either the target pricing user or one of the companies competitors.

“Accounts”: these are customers or potential customers of the target pricing user.

“Bids”: a bid is a request for products over a specified time period for which a custom price wilt be generated by the target pricing method.

“Products”: these are the products or services that the target pricing user produces and includes in a bid. In addition, products also include those produced by competitors.

“Options”: these are auxiliary sub-products that can be added to a product but which cannot be ordered on their own.

FIG. 4 illustrates how the key objects are inter-related. Companies produce the products that are contained in account bids. Accounts are the current and potential customers of the target pricing user. Each account is identified by a name and an account number. Associated with each account are values of the market segment variables.

An account contains 0 or more bids. An account will contain 0 bids if it is new or if no bids have been created for it to date. Although an account can contain more than 1 bid, only 1 bid may be active at any time. The remaining bids will either be inactive, rejected, pending or under construction.

An example of the active bidding:

| Account | | | Customer | Customer | |
|---|---|---|---|---|---|
| Number | Name | HQ Address | Since | Segment | Industry |
| 1 | Talus | Mt. View, CA | Jan. 1, 1990 | Small | 541 |
| 2 | Cisco | Menlo | Jan. 1, 1985 | Large | 334 |
| | | Park, CA | | | |
| 3 | Hertz | Park Ridge, NJ | Jan. 1, 1998 | Medium | 485 |
| 4 | Hyatt | Oakbrook, IL | Null | Null | 721 |
| 5 | Safeway | Oakland, CA | Null | Null | 445 |

A bid is a proposal to an account for delivery of products over a specified time period at a specified price. The bid contains at least one, and may contain more than one, product or service order. For example, a bid can contain the following information as. illustrated below: bid number, account, bid description, bid status, account executive, various dates, and one or more product orders.

| Bid | | | | |
|---|---|---|---|---|
| Number | Account | Description | Dates | Status |
| 1 | Talus | Annual Renewal | 1997 | Inactive |
| 2 | Talus | Annual Renewal | 1998 | Active |
| 3 | Cisco | Annual Renewal | 1997 | Inactive |
| 4 | Cisco | Annual Renewal | 1998 | Active |
| 5 | Hertz | Initial Proposal | 1998 | Active |
| 6 | Hyatt | Initial Proposal | 1997 | Rejected |
| 7 | Safeway | Initial Proposal | 1998 | Rejected |

A bid iss always in one of the following states (note that the state can change over time):

“Under construction”—The bid is being prepared, and has not been submitted to the customer.

“Pending”—The bid has been completed, target priced, and submitted to the customer, but no response has been obtained from the customer yet.

“Active”—A bid has been accepted,. and converted to a context, under which we are now offering products.

“Rejected”—A bid has been rejected outright or has expired unexercised.

“Inactive”—A bid that was previously active, but has run through the specified (active) time period.

A bid has associated with it the following dates:

“Initiation date”—Date when bid was initially submitted to the customer.

“Close date”—Date when a bid was either accepted, rejected or expired unexercised.

“Expiration date”—Date when a bid expires.

“Last modified date”—Date when the bid was last modified (either the product order was offered price was changed).

Products are the goods and services that a company provides to its customers at contracted or agreed terms. Products can consist of the following parameters: Name, number, part number, product line, set of options, cost model, price model, set of competing products, and company.

In the object model, it is preferable to differentiate between products and product orders. Products are the definition, and product orders are specific products which have been ordered in a bid. Product orders contain quantity, corresponding time period, and options. Some examples of products are:

| Number | Name | Product Line | Part Number |
|---|---|---|---|
| 1 | Inspiron 3500 D266Xt | Notebooks | 1001 |
| 2 | Dimension XPS R450 | Business Desktops | 2001 |
| 3 | Solo Portable PC | | 5150 |
| 4 | Hyperspace GX- | | 6200 |
| | 450XL | | |

Products orders are the specific products and options that have been ordered in a bid. The product order also specifies the quantity being tcquested and the time period that quantity relates to (e.g., per day, per week, per month, per quarter, per total). In addition, the product order specifies the options that have been ordered with this product. Finally, for any products which contain n-dimensional price or cost models, the specific dimensions corresponding to the price/cost model must also be recorded. An example of this is:

| Product | | | | Comp Net | |
|---|---|---|---|---|---|
| Number | Quantity | Period | Competitor | Price | Options |
| 1 | 25 | Total | 1 | 2700 | None |
| 2 | 50 | Total | 1 | 3999 | 2 |

Options are sub-products that can be ordered for a specific product. An option can only be ordered after the corresponding product has been ordered. Each product contains 0 or more options.

Options can consist of the following parameters: name, cost model, price model, competing options, and company.

In the object model, it is preferable to differentiate between options and option orders. Options are the definition, and option orders are the specific options ordered along with a particular product order. Option orders are contained in the product orders object as the following example illustrates.

| | | | Price | Cost | Competing |
|---|---|---|---|---|---|
| Number | Name | Company | Model | Model | Option |
| 1 | 32 MB memory | 0 | $99 | $50 | 3 |
| 2 | 3 yr. warranty | 0 | $150 | $50 | 4 |
| 3 | 32 MB memory | 1 | $60 | | |
| 4 | 3 yr. warranty | 1 | $0 | | |

Prices and costs can be modeled in the following ways:

| | |
|---|---|
| 0-D | A single value |
| 1-D | A vector of values |
| 2-D | A two-dimensional matrix |
| N-D | An n-dimensional matrix |
| Function (future) | A combination of the above models |

Example Price/Cost Models

“Function”: Pickup cost (0-D) + Transportation cost (2-D)

| 0-D | $20 | | | |
|---|---|---|---|---|
| | Quantity | 1 | 2-5 | 6+ |
| 1-D | Price | $20 | $18 | $15 |
| | | Weight | | |
| | Distance | 0-1 lbs. | 1-10 lbs. | 10+ lbs. |
| 2-D | 1 Zone | $10 | $8 | $5 |
| | 2 Zones | $15 | $12 | $8 |
| | 3 Zones | $19 | $14 | $9 |

Prices or costs can be retrieved from the tables from matching entries and interpolated for exact price.

For each of the target pricing user's products, a list of competing products is specified. Each of these competing products are to be treated like the target pricing user products. The only differences are that the company specified in the product is a competitor, and no cost model is specified since we do not need to compute costs for competitors.

The competitor net price (CNP) model used in the target pricing method estimates the prices competitors will offer to customers, including negotiated discounts. Logically, with all other factors being equal, the lower the competitor net price, the lower the target bid price will have to be to ensure the same probability of success. Conversely, the higher the competitor net price is, the more latitude one will have in generating a target bid price.

The target pricing method ideally uses accurate competitor net prices at the product level for every product in the specific. bid. The target pricing method can then. calculate a competitor net price for each competing product. While the competitor net prices can be estimated, the variance in the data can cause the target price obtained to not properly reflect the current market environment.

Thus, for each of the target pricing user's products that are intended to be competitively bid, there will be a competing product from each competitor in the system. For example, if the target pricing. user were Ford, and the competitors consisted of Honda and Toyota, then for each Ford product, such as the Taurus automobile, there would be a competing product from Honda (for example, the Accord automobile) and a competing product from Toyota (for example, the Camry automobile).

These competing products are maintained in the target pricing product model much like the target pricing user's products, with the following exceptions: no cost model is stored for them, since it is not necessary to estimate the cost of a competitor's offering. Competing. products are not maintained, as these are stored in the target pricing user's product table.

To compute a competing product's list price, the price model maintained in that product is utilized. Like all other products, the competitor's product price can be maintained as a n-dimensional model. All of the attributes needed for price modeling (i.e., the dimensions of the price model) must be obtained during the bid product order construction process. To the product's list price we must also add the price of the options. This is done by examining the user product model and retrieving the appropriate option prices. This process can best be clarified by the following example:

| Continuous Market Segments | Annual Revenue |
|---|---|
| Small | $0 to 50 M |
| Medium | $51 M to $400 M |
| Large | $400 M and over |

Target Pricing User: Ford
Competitors: Honda and Toyota
Product: Taurus

With the following 1-D price model:

| Taurus Price Model | |
|---|---|
| Quantity | Price |
| 1-9 | $20,000 |
| 10-99 | $19,000 |
| 100+ | $18,000 |

Taurus Competitors table:
Honda: Accord
Toyota: Camry

Taurus Options table:

| Option | Price | Honda option/price | Toyota option/price |
|---|---|---|---|
| Sunroof | $1000 | Moonroof - $800 | n/a |
| V-8 | $2000 | V-6 - $1500 | V-6 - $2000 |
| Leather seats | $800 | LX upgrade - $1200 | XLE upgrade - $2000 |

Product: Honda Accord

With the following 1-D price model:

| Honda Accord Price | Model |
|---|---|
| Quantity | Price |
| 1-5 | $22,000 |
| 6+ | $20,000 |

Product: Toyota Camry
With the following 0-D price model: $21,000
Example bids:
Bid#1: 1 Ford Taurus, with Sunroof and V-8
   Ford list price $20,000+$1000+$2000=$23,000
   Honda list price $22,000+$800+$150=$24,300
   Toyota list price $21,000+0+$2000=$23,000
Bid #2: 15 Ford Taurus with Sunroof and Leather seats
   Ford list price=$19,000+$1000+$800=$20,800
   Honda list price $20,000+$800+$1200=$22,000
   Toyota list price $21,000+0+$2000=$23,000

After computing the competitor list price, the net price is computed by applying the appropriate discounting model. The discounting options are as follows (note that each model varies by competitor): No segmentation used=a single discount value is applied against all products; product segmentation used=a different discount is available for each product market segmentation used=a different discount is available for each market segment; or combination of segments=combine more than one market segment, or the product segment with one or more market segments.
As before, this is best illustrated by example:
Honda: No segmentation used: Standard discount is 10%.

Toyota: Product and market segments are used as follows:

| | | Customer size | |
|---|---|---|---|
| Product | Market segment = Small | Medium | Large |
| Corolla | 0% | 5% | 10% |
| Camry | 0% | 10% | 15% |

This indicates that to compute the net price for Honda, we first compute the list price (including options) and then discount by 10%. To determine the net price for Toyota, we first need to determine what Customer size market segment the account falls into, and then apply the appropriate percentage against the product being priced. For example, for a Medium size customer purchasing the Camry, the discount would be 10%.

Because the competitor net price is a very important input for the target pricing method, precautions should be taken to ensure that the estimated competitor net price is reasonable. This is preferably accomplished by using an allowable range.

The allowable range is used to determine values that fall outside the allowable range during the target bid price calculation. If the value is outside the allowable range, the competitor net price must be changed until it falls within the allowable range, or the competitor net price model must be changed.

The target pricing method can be optimized for a particular user. At a macro level, the target pricing method recommends a target price for each bid. These bid level recommendations are then used to calculate product level price recommendations. The target prices at each level are determined by a non-linear optimization that maximizes expected marginal contribution subject to certain business rules (constraints). However, rather than providing a single specific bid price, the target pricing method preferably computes a range within which one can negotiate a final price with the customer.

One can either considers a “static” evaluation of bids, or at the macro level, capture market place dynamics by evaluating each bid order over multiple years. The multi-year optimization can model behavior like competitor response, changes in interest rates, changes in cost and price structures, and like parameters.

The target pricing method computes prices. in a sequence of four steps:

(1) Unconstrained bid-level prices.

(2) Constrained bid-level prices.

(3) Unconstrained product-level prices.

(4) Constrained product-level prices.

At each step, the method calculates a minimum price, target and maximum price. Internally, prices are computed as percentage discounts relative to list price, but the target pricing method user can choose to display them as absolute (cash) amounts, absolute (cash) discounts, or price ratios relative to a competitor net price.

The target pricing method user must gather all bid and account information necessary to calculate win probabilities. Examples of additional parameters or factors are: products, options and quantity ordered; list price and quantity for all products in the bid; cost and quantity for all products in the bid; competitor's net price for all products in the bid.

The target pricing method generates minimum, target and maximum prices as its output. The values produced are unconstrained and constrained prices for the entire bid, and unconstrained and constrained prices for each product.

The method of optimization particularly includes the steps of: solving the unconstrained bid level optimization, ignoring all strategic objectives; then solving the strategic objectives through application the constrained optimization; and then solving the unconstrained product optimization and the constrained product optimization.

In using the method, the MRM is used to analyze historical bid data and update the coefficients for the market response predictors with all account and bid characteristics. The M calculates all price-independent terms to generate a market response curve dependent only on the target pricing method users net price. Then, the user preferably performs a non-linear optimization routine to find the price which maximizes expected contribution:

expected contribution=win probability×sum over all products [list price×(1−discount)−variable cost of product i]×quantity of product i

Once bid optimization has been calculated, discounts are assigned for each product in the bid. While it is possible to simply assign discounts calculated at the bid level to each of the products within the bid, it is preferable to optimize the allocation to each product.

The method should maximize expected contribution (at the bid level) while allocating incentives for each of the products ordered in a given bid. Individual product incentives are aggregated to the bid level and are subject to any desired constraints. The incentives offered at the product level should aggregate to the bid level incentive determined by the bid optimization.

Strategic objectives can be used to control the default behavior from usage of the target pricing method Furthermore, strategic objectives determine constraints that impact the calculation of the optimal target price.

The method preferably uses 2 types of strategic objectives:

“Win (success) rates”—these are minimum or maximum bid win rates needed in particular market segments.

“Minimum profit margins”—these are minimum profit margins that are enforced with each bid.

The strategic overrides are preferably applied in the following sequence: (1) the unconstrained target price is calculated; and (2) conflicting strategic objectives are resolved. A feasible target range is calculated from the constraints determined by the strategic objectives. If the optimal target price is outside this feasible ranges the constrained target price that satisfies the constraints is found.

Among multiple minimum success rate objectives, choose the one with the highest success rate. Among multiple maximum success rate objectives, choose the one with the lowest success rate. Among multiple profit margin objectives, choose the one with the highest profit margin. If a success rate objective and a profit margin objective are in conflict, an arbitrary parameter set by the user determines precedence.

Minimum profit margins can be applied at 2 levels: At the individual product level, and at the product-line level. Alter the unconstrained target price has been calculated, the products minimum profit margins are being verified. If for any product, the minimum profit margin is being violated (for example, minimum profit on Product A is 10%, but method has calculated 8%), the target price should then be adjusted up to the minimum profit margin (that is, the price is increased until the minimum profit margin criteria is satisfied).

After all product margins have been adjusted for the bid, the overall margin is calculated. If the margin exceeds the minimum then prices for all products should be adjusted proportionately. For example, assume that the minimum profit margin is 10% and we have a product with a 5% margin. Then the price for each product will be increased proportionately until the overall bid margin is 10%.

The total cost of all strategic objectives for a particular bid is calculated, and alternately, will determine the costs of applying strategic objectives for an entire set of potential bids, on a forward-looking basis. The expected cost of the strategic objectives on a particular bid is simply the difference between the expected contribution without the strategic objectives and the expected contribution with the objectives.

The benefits of the target pricing can be used to gauge the performance of use of the target pricing method, and also to focus investigative efforts in areas where the target pricing method users' previous system does not appear to be operating effectively, The problems may be a result of user error, for example, incorrect input data, and thus should be rectified as soon as possible.

The benefit of target pricing is defined as increased expected contribution from using the target pricing. Mathematically this is expressed as: the expected contribution with target pricing less the expected contribution from using the company's pre-existing pricing method.

The preferred methodology to compute target pricing benefits is gathering a database of historical bid transactions, and for each bid, recording the following information:
“Target price”: as calculated by the system through its optimization process,
“Actual price”: as determined through ultimate purchase by the client (should normally fall inside the range computed by the target pricing method),
“Variable costs”: which are unique to each bid circumstance,
“TP win prob”: the win probability associated with the target price,
“AP win probe: the win probability associated with the Actual Price, using the same market response curve as for the TP win prob,
“Business-as-usual (AU) price”: the price which would have been used for the bid prior to target pricing, and
BAU win prob.”: the win probability associated with the BAU price, using the same market response curve as for the TP win prob.
   Using the above values, we can calculate:

Actual received benefits (i.e., the benefits that the user is currently experiencing)=(Actual price−cost)*AP win prob.−(3AU price−cost)*BAU win prob.; and

TP optimal benefits (i.e., the theoretical system potential if used correctly) (Target price−cost)*TP win prob.−(BAU price−cost)*BAU win prob.

These numbers can be calculated for each transaction, and Then the benefits numbers scaled to whatever level is desired. For example, the benefits could be aggregated by: competitor, region, account executive, customer type, industry segment, or other parameters.

In order to calculate the target pricing benefits, simulation of the pricing behavior of the company before target pricing is necessary. The user preferably selects from among three different pricing methods:

“Cost-plus pricing”: The price is a pre-specified amount (the profit margin) over cost. BAU price=Cost*(1+Gross Margin)

“List pricing”: The price is discounted a pre-specified amount from that maintained in the price list BAD price=List Price*(1−Discount)

“Going-rate pricing”: The price is based on competitors' prices, and is a pre-specified amount over or under their price. BAU price=Competitor Net Price*(1+Gross Margin)

Each of these BAU price models can vary by product, or according to any of the system's global dimensions. For the going-rate model, the target pricing user must choose how to calculate a “going rate” from multiple competitors' prices: options are the minimum, average or maximum of the competitors' net prices.

A few examples will make the pre-target pricing practices model clearer:

A company always priced at 10% above cost. This is a cost-plus model with no segmentation. Margin=10%. A company always priced at something above cost. For certain highly competitive products it was 5%, for the remaining proprietary products it was 20%. This is a cost-plus model with product segmentation. A company priced at something above cost. The margin varied by product and customer size. Cost-plus with product and market segmentation. A company discounted from its standard price list. The discounts varied by region and customer size. List pricing with two global dimensions. (region and customer size).

A company priced based on its competitors. Against Competitor A, the company priced 5% above, against Competitor B, the company priced 5% below. Going rate pricing.

The final step in the target pricing benefit computation is to take the BAU price calculated using one of the above methods, and calculate the associated win probability. This is done by looking up the win rate associated with that price from the market response curve (this also requires the competitor net price), Since the market response model is derived from unbiased historic information, and since it directly relates price to win probability, it can be used to compute the win probabilities for prices computed using non-target pricing methods. For comparisons to be meaningful, however, the same MRM parameters set must be used to compute both TP and BAU win probabilities.

While there has been shown a preferred and alternate embodiments of the present invention, it is to be understood that certain changes may be may in the form and arrangement of the steps without departing from the underlying ideas or principles of is invention as are set forth in the Claims. Further, all step-plus-function language in the claims is intended to embrace all corresponding, acts, and equivalents thereof as is known to one of skill in the art.

What is claimed is:

1-34. (canceled)

35. A computer-readable medium comprising computer executable instructions for executing a method for determining a target price for an auction item, the method comprising the steps of:
pricing the auction item using list price data in an electronically stored product model;
costing the auction item using cost data in the product model;
determining an equivalent competitor net price for the auction item using an electronically stored competitor net price model;
processing of said auction item pricing, said auction item costing, and said equivalent competitor net price to calculate a plurality of bids as a function of prices using the parameters from an electronically stored market response model that calculates winning probabilities for each of the prices; and
processing of said optimal bids to calculate a target price for the auction item, wherein the processing of said optimal bids comprises accessing an electronically stored optimization model that calculates a separate expected contribution value for each of the bids and selecting an optimal bid associated with a maximum expected contribution, wherein the expected contribution for a selected bid comprises a product of a marginal contribution for the selected bid and the winning probability for the selected bid, wherein the marginal contribution comprises revenues from winning the auction item at the selected bid minus immediately incurred costs from winning the auction item at the selected bid.

36. The computer-readable medium target price determining method of claim 35, wherein the market response model calculates the probability of winning auction item at a select price using an expediential distribution comprising price-independent terms reflecting a relative brand preference for the auction item and price-dependent terms reflecting price sensitivity.

37. The computer-readable medium target price determining method of claim 35, wherein the method further comprises comprising the step of the calculating a target price range for the auction item.

38. The computer-readable medium target price determining method of claim 37 wherein the step of processing, of said auction item pricing, said auction item costing, and said equivalent competitor net price to calculate a plurality of bids fiber comprises:
comparing the equivalent competitor net price to the target price range, and
if the an equivalent competitor net price falls outside the target price range, overriding the equivalent competitor net price with a predefined price within said target range prices.

39. The computer-readable medium target price determining method of claim 35, wherein the product and competitor price models are n-dimensional with stored data reflective of at least price and cot and wherein the pricing the auction item, the costing the auction item, and the determining an equivalent competitor net price each comprises an iterative linear interpolation of the stored data.

40. A computer-readable medium comprising computer executable instructions for executing a process of method for target pricing an auction item, the process comprising the steps of:
pricing the auction item using stored list prices in an electronically stored product model;
costing the auction item using stored costs in the product model;
determining an equivalent competitor net price for the auction item using an electronically stored competitor net price model;
processing of said auction item pricing, said auction item costing, and said equivalent competitor net price to calculate a probability of winning the auction item as a function of price using parameters from an electronically stored market response model; and
processing of said probability of wing to calculate a target price for the auction item that maximizes an expected contribution value using an electronically stored optimization model that determines competitive response to any potential price for the auction item, wherein the expected contribution the target price comprises a product of a marginal contribution for the target price and the winning probability for the target price, wherein the marginal contribution the target price comprises revenues from winning the auction item at the target price minus immediately incurred costs from winning the auction item at the target price.

41. The computer-readable medium target pricing method of claim 40, wherein the market response model calculates the probability of winning auction item at a select price using an expediential distribution comprising price-independent terms reflecting a relative brand preference for the auction item and price-dependent terms reflecting price sensitivity.

42. The computer-readable medium target pricing method of claim 41, wherein the electronically stored market response model includes coefficients for market response predictors based upon historical data, and
wherein the step of processing to calculate the probability of winning includes evaluating price-independent predictors and generating a market response curve reflecting a probability of winning the auction item as a function of a net price.

43. The computer-readable medium target pricing method of claim 42, wherein the step of evaluating the price-independent predictors comprises evaluating price independent predictors for at least a customer, a order, and a product.

44. The computer-readable medium target pricing method of claim 40, wherein the electronically stored product and competitor price models are n-dimensional with stored data reflective of at least price and cost, and wherein each of the steps of the computer automatically pricing the auction item, costing the auction item, and determining an equivalent competitor net price comprises iterative linear interpolations of the stored data.

45. The computer-readable medium target pricing method of claim 40, wherein the step of calculating an equivalent competitor net price further includes the steps of:
retrieving a reference price from a the product model for a specific auction item; and
applying an electronically stored discounting model to the reference price to determine a competitor net price for the specific auction item.

46. The computer-readable medium target pricing method of claim 40, wherein the method further comprises comprising the step of the calculating a target price range for the auction item.

47. The computer-readable medium target pricing method of claim 46, wherein the step of processing of said auction item pricing, said auction item costing, and said equivalent competitor net price to calculate a plurality of bids further comprises:
comparing the equivalent competitor net price to the target price range, and
if the an equivalent competitor net price falls outside the target price range, overriding the equivalent competitor net price with a predefined price within said target range prices.

48. The target price determining method of claim 36, wherein the market response model uses an equation:
$$probability of winning = \frac{1}{1 + {\sum }_{j ∈ J} {ⅇ}^{{k}_{j} + {m}_{j}}}$$
wherein, for J competitors, kⱼ is a sum of price-independent terns for competitor j and mⱼ is a sum of price-dependent terms for the competitor j.

49. The target pricing method of claim 41, wherein the market response model uses. an equation:
$$probability of winning = \frac{1}{1 + {\sum }_{j ∈ J} {ⅇ}^{{k}_{j} + {m}_{j}}}$$
wherein, for J competitors,, kⱼ is a sum of price-independent terms for competitor j and mⱼ is a sum of price-dependent terms for the competitor j.
